(19) United States
(12) Patent Application Publication
(10) Pub. No.: US 2024/0237064 A1
(43) Pub. Date: Jul. 11, 2024

(54) WIRELESS COMMUNICATION DEVICE, WIRELESS COMMUNICATION TERMINAL, AND WIRELESS COMMUNICATION METHOD

(71) Applicant: Sony Group Corporation, Tokyo (JP)

(72) Inventors: Ryuichi HIRATA, Tokyo (JP); Ken TANAKA, Tokyo (JP); Shigeru SUGAYA, Tokyo (JP)

(73) Assignee: Sony Group Corporation, Tokyo (JP)

(21) Appl. No.: 18/559,063

(22) PCT Filed: Feb. 2, 2022
(86) PCT No.: PCT/JP2022/003953

§ 371 Date: Nov. 6, 2023

(30) Foreign Application Priority Data
May 14, 2021 (JP) 2021-082170

(51) Int. Cl. H04W 74/0808

(52) U.S. Cl. CPC H04W 74/0808

(57) ABSTRACT

The present technology relates to a wireless communication device, a wireless communication terminal, and a wireless communication method that may increase the opportunities for transmission and reception in communication on a plurality of links.

The wireless communication device communicates with a wireless communication terminal on a plurality of links, and transmits, when receiving a transmission request frame for a first frame transmitted from the wireless communication terminal on a first link, transmission_available_time specifying information that specifies a transmission_available_time of the wireless communication terminal on the first link, to the wireless communication terminal. The present technology is applicable to a wireless communication system.

### TECHNICAL FIELD

The present technology relates to a wireless communication device, a wireless communication terminal, and a wireless communication method, and more particularly, to a wireless communication device, a wireless communication terminal, and a wireless communication method that may increase the opportunities for transmission and reception in communication on a plurality of links.

### BACKGROUND ART

A wireless communication using a plurality of links (multi-link operation (MLO)) has been discussed as a method that responds to a high transfer rate request such as the 8K transfer and xReality (xR). A “link” is a wireless transfer line that may transfer data between two wireless communication devices.

In performing the MLO, each link is selected from a plurality of mutually independent wireless transfer lines that are divided, for example, in the frequency domain.

A device that responds to the MLO is called a multi-link device (MLD). The MLD is a logical entity that contains two or more STAs and has only one service access point (SAP) to the upper layer. An MLD in which each contained STA is an AP is called an AP MLD, and an MLD in which each contained STA is a non-AP is called a non-AP MLD.

The MLD transfers using a plurality of links. Note, however, that in the MLD, due to factors such as the degree of frequency proximity between links, a transmitted signal may leak from one link and strongly interfere with a received signal in other links, thus degrading the communication quality.

A pair of links in which a restriction occurs when transmitting and receiving at the same time between the links as describe above is called a nonsimultaneous transmit and receive (NSTR) link pair. In contrast, a pair of links in which no restriction occurs when transmitting and receiving signals at the same time between the links, such as no impact on the communication quality from electric power leakage between the links, is called a simultaneous transmit and receive (STR) link pair.

Hereinafter, in a case where an AP MLD and a non-AP MLD are communicating on a certain link pair, it is defined that the AP MLD is an STR AP MLD and the non-AP MLD is a non-STR non-AP MLD if the link pair is the STR link pair for the AP MLD and the NSTR link pair for the non-AP MLD.

When the non-STR non-AP MLD is transmitting on one link, it may not detect the media condition on the other link due to the interference from the transmission. In such a case, Non-Patent Document 1 defines that the non-STR non-AP MLD should wait a certain amount of time after transmission on a certain link (MediumSyncDelay).

Note that Patent Document 1 discloses the way a wireless station obtains information indicating the wireless communication condition of a peripheral wireless station via a network and informs the mate wireless station of it.

### CITATION LIST

### Non-Patent Document

Non-Patent Document 1: Dibakar Das, Duncan Ho, “Blindness issue for non-STR operations-followup”, IEEE 802.11-20/1009r10, Jan. 14, 2021 Internet <https://mentor.ieee.org/802.11/dcn/20/11-20-1009-10-00be-multi-link-hidden-terminal-followup.pptx retrieved on 6 Apr. 2021>

### Patent Document

PATENT DOCUMENT 1: Japanese Patent Application Laid-open No. 2010-233095

### SUMMARY OF THE INVENTION

### Problems to be Solved by the Invention

However, in the technology described in Non-Patent Document 1, there is a possibility that the non-STR non-AP MLD should wait a long time due to the transmission on the other link or MediumSyncDelay and may not perform the transmission or reception.

Furthermore, Patent Document 1 does not refer to information such as the length of a frame that the wireless station transmits. Therefore, in the technology described in Patent Document 1, it is impossible to adjust the transmission time or waiting time between the links, thus making it difficult to reduce the waiting time of the non-STR non-AP MLD.

The present technology was accomplished in light of the above situation and is intended to make it possible to increase the opportunities for transmission and reception in communication on a plurality of links.

### Solutions to Problems

A wireless communication device of a first aspect of the present technology includes: a communication unit configured to communicate with a wireless communication terminal on a plurality of links; and a communication control unit configured to transmit, when receiving a transmission request frame for a first frame transmitted from the wireless communication terminal on a first link, transmission_available_time specifying information that specifies a transmission_available_time of the wireless communication terminal on the first link, to the wireless communication terminal.

A wireless communication terminal of a second aspect of the present technology includes: a communication unit configured to communicate with a wireless communication device on plurality of links; and a communication control unit configured to transmit a first frame to the wireless communication device on a first link in accordance with a transmission_available_time of the first frame on the first link that is specified in transmission_available_time specifying information included in a response frame transmitted by the wireless communication device in response to a transmission request frame for the first frame transmitted to the wireless communication device on the first link.

In a first aspect of the present technology, a communication is performed with a wireless communication terminal on a plurality of links. Then, when receiving a transmission request frame for a first frame transmitted from a wireless communication terminal on a first link, transmission_available_time specifying information that specifies a transmission_available_time of the wireless communication terminal on the first link is transmitted to the wireless communication terminal.

In a second aspect of the present technology, a communication is performed with a wireless communication device on a plurality of links. Then, a first frame is transmitted to the wireless communication device on a first link in accordance with a transmission_available_time of the first frame on the first link that is specified in transmission_available_time specifying information included in a response frame transmitted by the wireless communication device in response to a transmission request frame for the first frame transmitted to the wireless communication device on the first link.

### BRIEF DESCRIPTION OF DRAWINGS

FIG. 1 is a view showing a configuration example of a wireless communication system according to an embodiment of the present technology.

FIG. 2 is a view showing an example of the conventional sequence.

FIG. 3 is a view showing another example of the conventional sequence.

FIG. 4 is a view showing a configuration example of an MLO CTS frame according to an embodiment of the present technology.

FIG. 5 is a view showing an example of a sequence of the present technology.

FIG. 6 is a block diagram showing a configuration example of a wireless communication device.

FIG. 7 is a flowchart describing a process of an AP MLD.

FIG. 8 is a flowchart describing a process of a non-AP MLD.

FIG. 9 is a block diagram showing a configuration example of a computer.

### MODE FOR CARRYING OUT THE INVENTION

Hereinafter, modes for carrying out the present technology will be described. The description will be made in the following order.
1. System Configuration
2. Conventional Technology
3. Embodiments
4. Others

### 1. System Configuration

### <Configuration Example of Wireless Communication System>

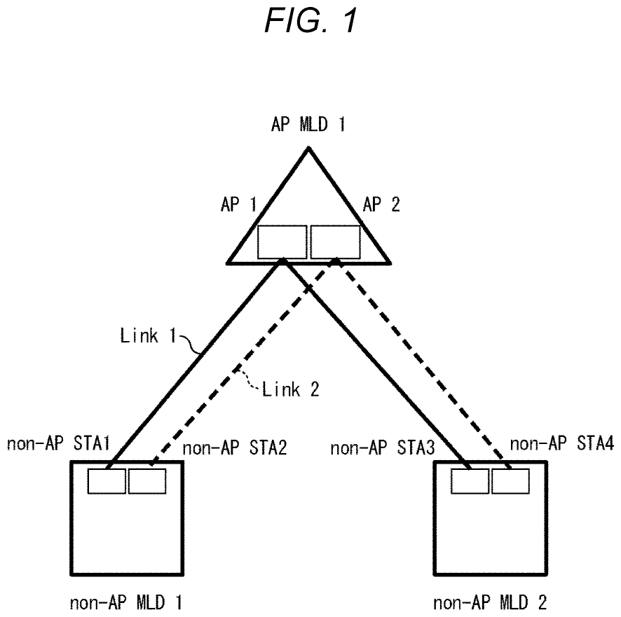

FIG. 1 is a view showing a configuration example of a wireless communication system according to an embodiment of the present technology.

In the wireless communication system of FIG. 1, data is transmitted and received by wireless communication using a plurality of links (MLO).

A “link” is a wireless transfer line that may transfer data between two wireless communication devices. In performing the MLO, each link is selected from a plurality of mutually independent wireless transfer lines that are divided, for example, in the frequency domain. Each link uses a channel selected from a plurality of channels included in any band of frequency bands such as, for example, 2.4 GHz band, 5 GHz band, 6 GHz band, and 920 MHz band.

A device that responds to the MLO is called an MLD, as described above. The MLD is a logical entity that contains two or more STAs and has only one SAP to the upper layer.

The wireless communication system of FIG. 1 includes one AP MLD1 and two non-AP MLDs of non-AP MLD1 and non-AP MLD2. Non-AP MLD1 and non-AP MLD2 are connected to AP MLD1.

In FIG. 1, solid lines joining AP MLD1 and non-AP MLD1 and non-AP MLD2 represent a link1 (first link) and broken lines joining AP MLD1 and non-AP MLD1 and non-AP MLD2 represent a link2 (second link).

AP MLD1 is a wireless communication device that operates as a base station corresponding to the MLO. AP MLD1 contains AP1 and AP2. AP1 is a logical entity that operates using link1. AP2 is a logical entity that operates using link2.

Each of non-AP MLD1 and non-AP MLD2 is a wireless communication device that operates as a terminal corresponding to the MLO. Non-AP MLD1 contains non-AP STA1 and non-AP STA2. Non-AP STA1 is a logical entity that operates using link1. Non-AP STA2 is a logical entity that operates using link2.

Non-AP MLD2 contains non-AP STA3 and non-AP STA4. Non-AP STA3 is a logical entity that operates using link1. Non-AP STA4 is a logical entity that operates using link2.

In FIG. 1, AP1 mutually communicates with non-AP STA1 and non-AP STA3 using link1. AP2 mutually communicates with non-AP STA2 and non-AP STA4 using link2.

Link1 and link2 may be two channels selected from the same or different frequency bands.

Furthermore, the links used between AP MLD1 and non-AP MLD1 and between AP MLD1 and non-AP MLD2 are not limited to two, and three or more links may be used for communication. Furthermore, the number of non-AP MLDs is not limited to two, and three or more non-AP MLDs may be connected to AP MLD1.

### 2. Conventional Technology

As described above, the MLD transfers using a plurality of links. However, in the MLD, due to factors such as the degree of frequency proximity between links, a transmitted signal may leak from one link and strongly interfere with a received signal in other links, thus degrading the communication quality.

A pair of links in which a restriction occurs when transmitting and receiving at the same time between the links is called an NSTR link pair as described above. In contrast, a pair of links in which no restriction occurs when transmitting and receiving signals at the same time between the links, such as no impact on the communication quality from electric power leakage between the links, is called an STR link pair as described above.

Furthermore, in a case where an AP MLD and a non-AP MLD are communicating on a certain link pair, it is defined that the AP MLD is a STR AP MLD and the non-AP MLD is a non-STR non-AP MLD if the link pair is the STR link pair for the AP MLD and the NSTR link pair for the non-AP MLD, as described above. Therefore, hereinafter, an AP MLD indicates the STR AP MLD and a non-AP MLD indicates the non-STR non-AP MLD in the present specification, even if there is no particular description of the STR or non-STR.

Note that when the AP MLD and non-AP MLDs are communicating using three links (links 1, 2, 3), for example, a combination of links may be assumed in which link1 and link2 are the NSTR link pair, while link1 and link3 as well as link2 and link3 are the STR link pairs. In this case, the operations described in the present specification are applicable to the operations on link1 and link2.

When the non-STR non-AP MLD is transmitting on one link (link1), it may not detect the media condition on the other link (link2) due to the interference from the transmission. In such a case, the above described Non-Patent Document 1 defines that the non-STR non-AP MLD should wait a certain amount of time after transmission on a certain link (MediumSyncDelay).

However, in Non-Patent Document 1, there is a possibility that the non-STR non-AP MLD should wait a long time due to MediumSyncDelay and may not perform the transmission or reception.

### Conventional Sequence Example 1

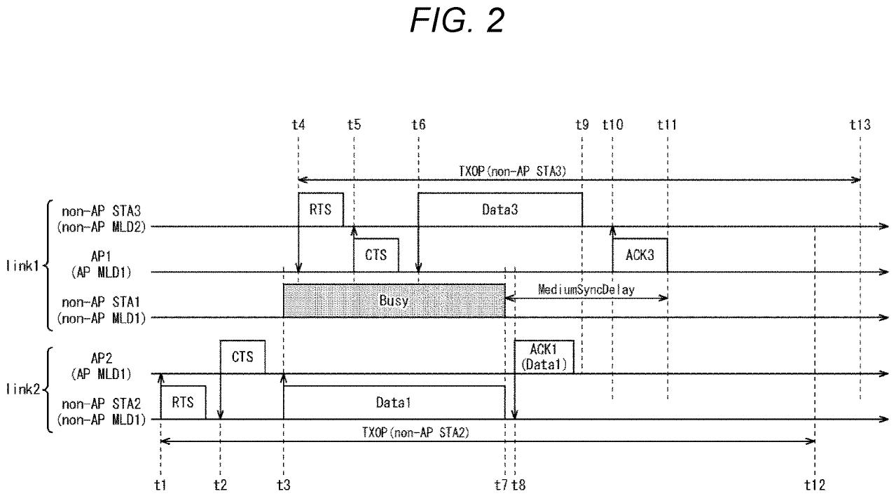

FIG. 2 is a view showing a sequence for the non-STR non-AP MLD that waits due to MediumSyncDelay.

FIG. 2 shows that non-AP MLD1 and non-AP MLD2, which are the non-STR non-AP MLDs, are connected to AP MLD1 and communicating using link1 and link2, respectively.

In FIG. 2, non-AP STA2 acquires the transmission right on link2 and transmits to AP2 a request to send (RTS) frame, which is a transmission request, at time t1. TXOP, which is the time during which continuous transmission is possible because of the transmission right of non-AP STA2, is time t1 to time t12.

When receiving the RTS frame transmitted from non-AP STA2, AP2 transmits to non-AP STA2 a clear to send (CTS) frame, which is a response to the RTS frame, at time t2. This allows non-AP STA2 to start to transmit Data1 frame to AP2 at time t3.

Due to this transmission of Data1 frame, non-AP STA1 is in a busy state at time t3 and may not sense the media information on link1.

Meanwhile, non-AP STA3 acquires the transmission right on link1 and transmits the RTS frame to AP1 at time t4. The TXOP of non-AP STA3 is time t4 to time t13.

When receiving the RTS frame transmitted from non-AP STA3, AP1 transmits to non-AP STA3 the CTS frame, which is the response to the RTS, at time t5. This allows non-AP STA3 to start to transmit Data3 frame to AP1 at time t6.

Non-AP STA2 ends the transmission of Data1 frame at time t7 and so non-AP STA1 is no longer in the busy state. Then, AP2 transmits ACK1 frame in response to Data1 frame at time t8.

In contrast, non-AP STA1 starts a waiting operation by the MediumSyncDelay timer at time t7. Thus, non-AP STA1 has to wait at least until it senses ACK3 frame transmitted by AP1 in response to Data3 frame.

### Conventional Sequence Example 2

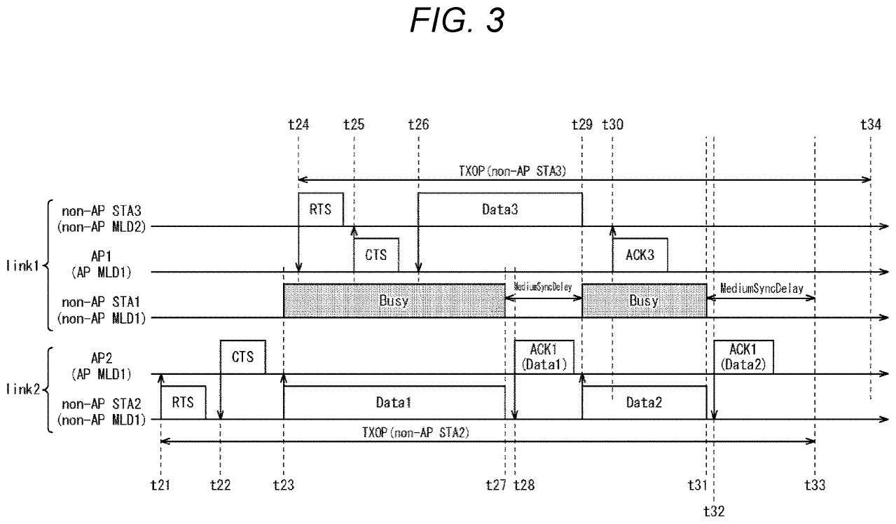

FIG. 3 is a view showing a sequence for non-AP STA2 that starts to transmit Data2 frame while waiting due to MediumSyncDelay of FIG. 2.

The same process is performed in time t21 to t28 of FIG. 3 as in time t1 to t8 of FIG. 2 and so its description is omitted here.

Note that the TXOP of the transmission right acquired by non-AP STA2 at time t21 is time t21 to time t33. Furthermore, the TXOP of the transmission right acquired by non-AP STA3 at time t24 is time t24 to time t34.

At time t27 of FIG. 3, non-AP STA2 ends the transmission of Data1 frame and so non-AP STA1 is no longer in the busy state, but is waiting by the MediumSyncDelay timer. AP2 transmits ACK1 frame in response to Data1 frame at time t28.

When receiving ACK1 from AP2, non-AP STA2 is within the TXOP of non-AP STA2 and so it starts to transmit Data2 frame to AP2 at time t29.

Due to this transmission of Data2 frame, non-AP STA1 is in the busy state at time t29 and may not sense the media information on link1. In other words, non-AP STA1 may not sense ACK3 frame transmitted at time t30 after the transmission of Data3 frame is ended.

When non-AP STA2 ends the transmission of Data2 frame at time t31, non-AP STA1 is no longer in the busy state. Then, AP2 transmits ACK2 frame in response to Data2 frame at time t32.

However, non-AP STA1 may not sense ACK3 frame, and so has to wait a long time due to MediumSyncDelay until the TXOP of non-AP STA3 is completed at time t33.

Therefore, AP MLD1 may not transmit a data frame to non-AP MLD1 for a long time or perform a downlink multi user (DL MU) transmission or the like, which includes non-AP MLD1 in the destination, thus reducing the media use efficiency.

### 3. Embodiments

In the present technology, in communication on a plurality of links, when the RTS frame is received from non-AP STA on link1, transmission_available_time specifying information specifying a transmission_available_time is transmitted on link1 as a response to the RTS frame.

Note that this embodiment describes an example in which a medium access control (MAC) frame is transmitted in a PHY protocol data unit (PPDU) format that is added with a PHY preamble, a PHY header, and a packet extension (PE) and the like.

### Configuration Example of MLO CTS Frame

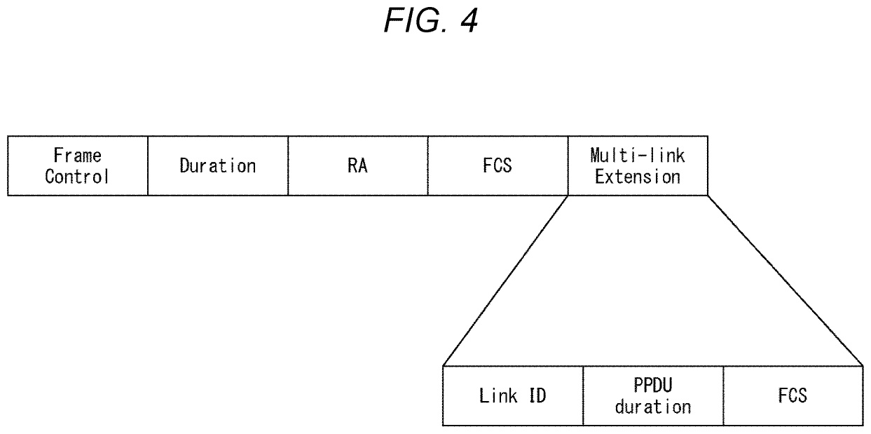

FIG. 4 is a view showing a configuration example in a MAC layer of an MLO CTS frame including the transmission_available_time specifying information.

In FIG. 4, the MLO CTS frame includes fields of a frame control, a duration, a receiving STA address (RA), a frame check sequence (FCS), and a multi-link extension.

The MLO CTS frame of FIG. 4 is an extended frame that includes a conventional CTS frame added with an extension field of a multi-link extension.

The frame control includes information indicating that this frame is a frame added with a control frame extension.

The duration includes information indicating the communication period covered by this frame.

The RA includes information indicating the destination device. For example, a device-specific MAC address may be indicated in the RA.

The FCS includes an error detection code.

The multi-link extension includes subfields of a link ID, a PPDU duration, and an FCS.

The link ID includes information indicating the identifier of the used link.

The PPDU duration includes information indicating a transmission_available_time. The information indicating the transmission_available_time is set with, for example, “until the transmission end time of non-AP STA in the non-STR non-AP MLD transmitted on link2.” Note that as long as the transmission end time is known, the information indicating the transmission_available_time may be set with a transmission_available_time or a transmission end time.

The FCS includes an error detection code.

### Sequence Example of Present Technology

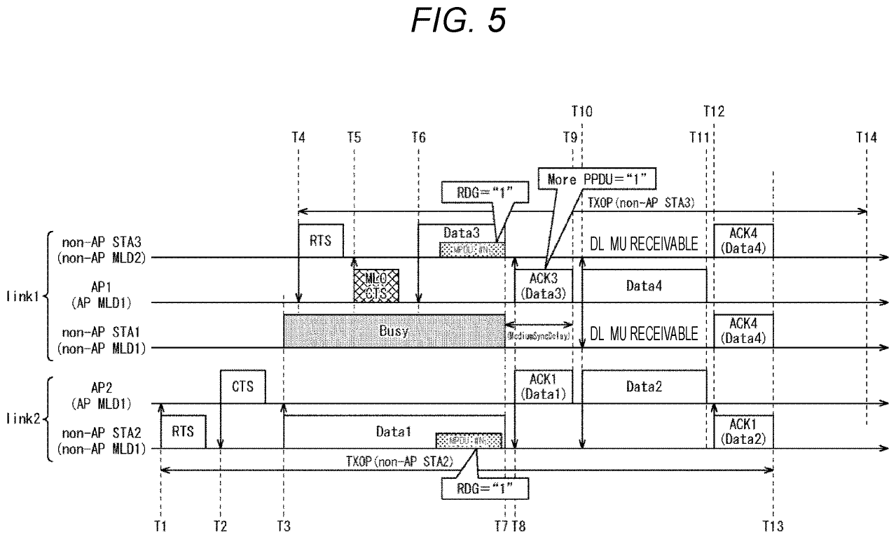

FIG. 5 is a view showing a sequence example in the present technology.

FIG. 5 shows that in the wireless communication system of FIG. 1, AP MLD1 is connected with non-AP MLD1 and non-AP MLD2, which are the non-STR non-AP MLDs, and non-AP MLD1 and non-AP MLD2 are communicating using link1 and link2, respectively, as in FIG. 2.

Then, in the example of FIG. 5, when AP MLD1 receives the RTS frame from non-AP STA3 on link1, while receiving, on link2, a data frame from non-AP STA2 in non-AP MLD1, which is the non-STR non-AP MLD, AP MLD1 transmits the MLO CTS frame described above with reference to FIG. 4, as a response to the RTS frame. Furthermore, the data frame in the example of FIG. 5 may be a frame including at least one of data, management information, and control information.

Note that AP MLD1 and non-AP MLD1 and non-AP MLD2 may exchange, at connection, capability information including information that indicates whether or not they respond to the transmission and reception of the MLO CTS frame and the control operation of the frame transmission time.

Furthermore, AP MLD1 may previously collect information about the amount of buffers of subordinate non-AP MLD1 and non-AP MLD2 and the priority and type of data in the buffers.

The non-AP STA2 acquires the transmission right on link2 at time T1 of FIG. 5 and transmits the RTS frame to AP2. The TXOP by the transmission right of non-AP STA2 is time T1 to time T13.

When receiving the RTS frame transmitted from non-AP STA2, AP2 transmits to non-AP STA2 the CTS frame as a response to the RTS frame, at time T2. This allows non-AP STA2 to start to transmit Data1 frame to AP2 at time T3.

Note that the reverse direction grant (RDG)/More (reverse direction grant/addition) PPDU subfields in Data1 frame include change_availability_information of the communication direction that indicates whether or not to change the communication direction. At this time, non-AP STA2 may transmit Data1 frame by setting the change_availability_information of the communication direction to 1 using the Reverse Direction Protocol in the RDG/More PPDU subfields in Data1 frame. Thus, AP2 may transmit Data2 frame after transmitting the ACK frame in response to Data1 frame.

Due to this transmission of Data1 frame, non-AP STA1 is in the busy state at time T3 and may not sense the media information on link1.

Meanwhile, non-AP STA3 acquires the transmission right on link1 at time T4 and transmits the RTS frame to AP1. The TXOP by the transmission right of non-AP STA3 is time T4 to time T14.

When receiving the RTS frame transmitted from non-AP STA3, AP1 determines whether or not it is necessary to specify the Data3 frame transmission time of non-AP STA3 on the basis of information in the buffers of AP1 itself and information collected from the subordinate non-AP STAs.

If it is determined that it is necessary to specify the Data3 frame transmission time of non-AP STA3, then AP1 transmits the MLO CTS frame including the transmission_available_time specifying information that describes the transmission_available_time of Data3 frame, at time T5. The transmission_available_time specifying information specifies, for example, the reception end time of Data1 frame.

After receiving the MLO CTS frame, non-AP STA3 transmits Data3 frame in accordance with the time described in the MLO CTS frame, at time T6.

At this time, non-AP STA3 may transmit Data3 frame by setting the change_availability_information of the communication direction in the RDG/More PPDU subfields in Data3 frame to 1 using the Reverse Direction Protocol. Thus, AP1 may transmit Data4 frame after transmitting ACK3 frame in response to Data3 frame.

At time T7, non-AP STA2 ends the transmission of Data1 frame and non-AP STA3 ends the transmission of Data3 frame. At the same time, non-AP STA1 releases the busy state and starts the waiting operation by the MediumSyncDelay timer.

At time T8, AP1 transmits ACK3 frame in response to Data3 frame and AP2 transmits ACK1 frame in response to Data1 frame. At this time, AP1 may transmit ACK3 frame by setting the RDG/More PPDU subfields in ACK3 frame to 1. Likewise, AP2 may transmit ACK1 frame by setting the RDG/More PPDU subfields in ACK1 frame to 1.

At time T9, AP1 ends the transmission of ACK3 frame and AP2 ends the transmission of ACK1 frame. At this time, non-AP STA1 receives ACK3 frame and releases the waiting by the MediumSyncDelay timer.

At time T10, AP1 starts to transmit, using the DL MU, Data4 frame that includes non-AP STA1 and non-AP STA3 in the destination, and AP2 starts to transmit, using the DL MU, Data2 frame that includes non-AP STA2 in the destination.

At time T1l, AP1 ends the transmission of Data4 frame and AP2 ends the transmission of Data2 frame.

At time T12, non-AP STA1 and non-AP STA3 transmit ACK4 frame in response to Data4 frame, and non-AP ST2 transmits ACK2 frame in response to Data2 frame. At time T13, the transmission of ACK4 frame ends and the transmission of ACK2 frame ends.

### <Configuration of Device>

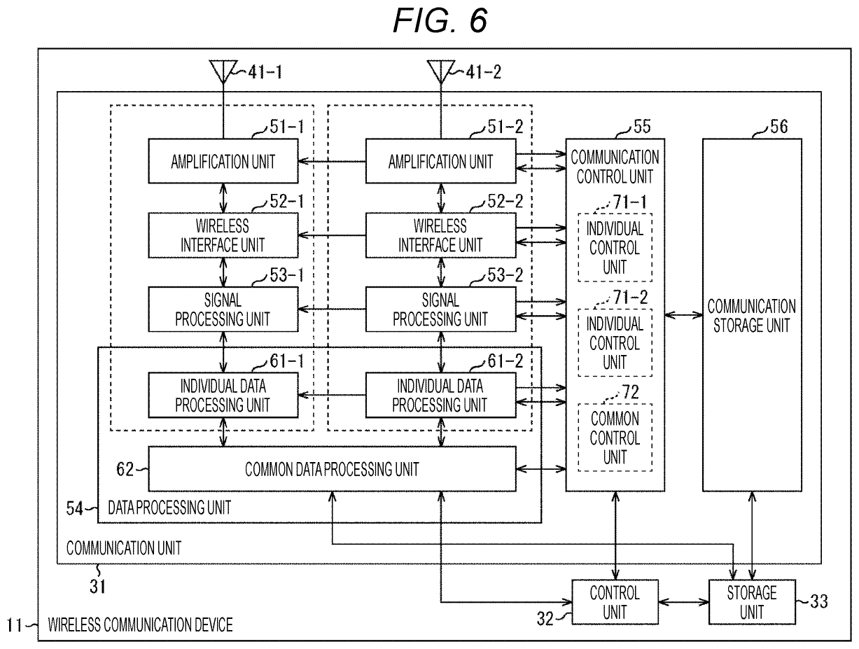

FIG. 6 is a block diagram showing a configuration example of a wireless communication device to which the present technology is applied.

FIG. 6 shows a wireless communication device 11, which is a wireless communication device that operates as an AP MLD or a non-AP MLD.

The wireless communication device 11 includes a communication unit 31, a control unit 32, a storage unit 33, and antennas 41-1 and 41-2. The antennas 41-1 and 41-2 are collectively referred to as an antenna 41 if there is no need to distinguish them.

The communication unit 31 transmits and receives data. The communication unit 31 is configured to include amplification units 51-1 and 51-2, a wireless interface unit 52-1, a wireless interface unit 52-2, and signal processing units 53-1 and 53-2. Also, the communication unit 31 is configured to include a data processing unit 54, a communication control unit 55, and a communication storage unit 56.

Note that the amplification units 51-1 and 51-2, the wireless interface units 52-1 and 52-2, and the signal processing unit 53-1 and 53-2 are collectively referred to as an amplification unit 51, a wireless interface unit 52, and a signal processing unit 53, respectively, if there is no need to distinguish them.

At transmission, the amplification unit 51 amplifies an analog signal supplied from the wireless interface unit 52 to a predetermined electric power, and outputs the analog signal with the amplified electric power to the antenna 41. At reception, the amplification unit 51 amplifies an analog signal supplied from the antenna 41 to a predetermined electric power, and outputs the analog signal with the amplified electric power to the wireless interface unit 52.

The amplification unit 51 may have a part of its functions contained in the wireless interface unit 52. Furthermore, the amplification unit 51 may have a part of its functions be a component outside the communication unit 31.

At transmission, the wireless interface unit 52 converts a transmission symbol stream from the signal processing unit 53 to an analog signal. Then the wireless interface unit 52 performs filtering, up-convert to the carrier frequency, and a phase control to the analog signal, and outputs the analog signal after the phase control to the amplification unit 51.

At reception, the wireless interface unit 52 performs a phase control, down-convert, inverse filtering to an analog signal supplied from the amplification unit 51. Then the wireless interface unit 52 outputs the reception symbol stream, which is the result of conversion into a digital signal, to the signal processing unit 53.

At transmission, the signal processing unit 53 performs encoding, interleave, and modulation or the like to the data unit supplied from the data processing unit 54. Then the signal processing unit 53 adds a physical header to the data unit and outputs the transmission symbol stream to each wireless interface unit 52.

At reception, the signal processing unit 53 analyzes the physical header of the reception symbol stream supplied from each wireless interface unit 52, performs demodulation, deinterleave, and decoding or the like to the reception symbol stream, and generates a data unit. The generated data unit is output to the data processing unit 54.

Note that the signal processing unit 53 performs a complex channel characteristics estimation and a spatial separation process as necessary.

The data processing unit 54 includes individual data processing units 61-1 and 61-2 and a common data processing unit 62. The individual data processing units 61-1 and 61-2 are collectively referred to as an individual data processing unit 61 if there is no need to distinguish them.

At transmission, the individual data processing unit 61 performs a channel access operation based on a carrier sense, addition of a media access control (MAC) header and addition of an error detection code to data to be transmitted, and a coupling process of multiple data units.

At reception, the individual data processing unit 61 performs a decoupling process of the MAC header of the received data unit, an analysis and an error detection, and a retransmission request operation.

At transmission, the common data processing unit 62 performs sequence management of data stored in the communication storage unit 56 and control information and management information received from the communication control unit 55. Furthermore, the common data processing unit 62 performs an encryption process of the management information and control information or the like to generate a data unit, and allocates the generated data unit to the individual data processing units 61-1 and 61-2.

At reception, the common data processing unit 62 performs an analysis process and a reordering process of the data unit.

The antenna 41, the amplification unit 51, the wireless interface unit 52, the signal processing unit 53, and the individual data processing unit 61 form one set (hereinafter also referred to as an individual communication set) for each of the same branch number, as surrounded by a broken line.

In a case where the wireless communication device 11 is the AP MLD, the individual communication set means the AP. In a case where the wireless communication device 11 is the non-AP MLD, the individual communication set means the non-AP STA.

Each set provides a component of the wireless communication device 11 and performs a wireless communication on each link. Furthermore, each set may include the storage unit 33.

Note that the operations of the individual data processing unit 61 and common data processing unit 62 are not limited to the above described operations and one may perform the other's operation, for example. For example, the individual data processing unit 61 may be defined so that all the functions of the common data processing unit 62 are performed for each individual communication set.

Also, each link used by each set may have a different frequency band. Furthermore, the signal processing unit 53 and individual data processing unit 61 may be configured to form one set for each of the same branch number and two or three or more of the sets may be configured to be connected to one wireless interface unit 52.

The communication control unit 55 controls the operation of each unit and the information transfer between each unit in the communication unit 31. Furthermore, the communication control unit 55 controls transfer of the control information and management information to be notified to a different wireless communication device to the individual data processing unit 61 and common data processing unit 62.

The communication control unit 55 includes individual control units 71-1 and 71-2 that control each individual communication set, and a common control unit 72 that performs a control common to the common data processing unit 62 and each individual communication set. The individual control units 71-1 and 71-2 are collectively referred to as an individual control unit 71 if there is no need to distinguish them.

In the present technology, the individual control unit 71 transfers the control information (length information such as LENGTH) included in the received data unit to other different individual control units 71, and controls each unit to transmit the MLO CTS frame including the transmission_available_time specifying information that specifies the transmission_available_time to other different wireless communication devices. At this time, the control information may be transferred via the common control unit 72.

The communication storage unit 56 stores information used by the communication control unit 55. Furthermore, the communication storage unit 56 stores data to be transmitted and received data.

The control unit 32 includes a central processing unit (CPU), a read only memory (ROM), and a random access memory (RAM) or the like. The control unit 32 executes a program stored in the ROM or the like and controls the communication unit 31 and communication control unit 55. Furthermore, the control unit 32 may perform some of the operations of the communication control unit 55 instead. Furthermore, the communication control unit 55 and control unit 32 may be configured as one block.

The storage unit 33 stores information used by the communication unit 31 and control unit 32. Furthermore, the storage unit 33 may perform some of the operations of the communication storage unit 56 instead. The storage unit 33 and communication storage unit 56 may be configured as one block.

Note that the antenna 41, amplification unit 51, wireless interface unit 52 may form one set for each of the same branch number and two or three or more of the sets may provide a component of the wireless communication device 11. Furthermore, the communication unit 31 is achieved by one or more LSIs.

The individual data processing unit 61 is also referred to as a lower MAC. The common data processing unit 62 is also referred to as an upper MAC or Higher MAC. Furthermore, a set of the individual data processing unit 61 and common data processing unit 62 is also referred to as an AP entity or non-AP entity. Also, the communication control unit 55 is referred to as a Multi-link Device (MLD) management entity.

### <Process of AP MLD>

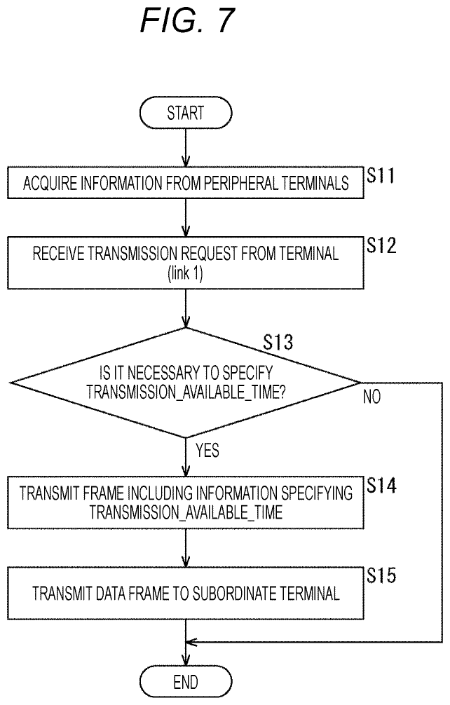

FIG. 7 is a flowchart describing a process of AP MLD1.

In step S11, the communication control unit 55 of AP MLD1 acquires information from peripheral terminals. For example, AP2 of AP MLD1 receives Data1 frame from non-AP STA2 in non-STR non-AP MLD2 on link2 and acquires the information described in the frame (at time T3 of FIG. 5).

At that time, the change_availability_information of the communication direction in the RDG/More PPDU subfields of the PPDU may be set to 1 using the Reverse Direction Protocol, as described above. Furthermore, when acquiring the information, information about the buffer condition (buffer status report) of the subordinate non-AP STA may be received.

In step S12, the communication control unit 55 of AP MLD1 receives an RTS frame, which is a transmission request, from a certain terminal. For example, AP1 of AP MLD1 receives the RTS frame from non-AP STA3 in non-AP MLD2 on link1 (at time T4 of FIG. 5).

In step S13, the communication control unit 55 of AP MLD1 determines whether or not it is necessary to specify the transmission_available_time.

This determination is performed on the basis of at least one of the information from the peripheral terminals acquired in step S11, the information in the RTS frame received in step S12, and the information in the wireless communication device 11 itself.

For example, if the transmission request time from non-AP STA3 in non-AP MLD2 on link1 is longer than the transmission end time of non-AP STA2 in non-AP MLD1 on link2, it is determined that it is necessary to specify the transmission_available_time.

For example, if DL data addressed to an MLD that is the source of Data1 frame received on link2 is present in the buffer of AP MLD1, for example, it is determined that it is necessary to specify the transmission_available_time.

For example, if high-priority data is absent in the buffer of non-AP STA3, it is determined that it is necessary to specify the transmission_available_time.

For example, if non-AP STA3 needs to shift to the doze state (sleep state) within the duration requested in the RTS frame received by AP MLD1 in step S12 to reduce the power consumption of non-AP STA3, it is determined that it is necessary to specify the transmission_available_time.

If it is determined that it is necessary to specify the transmission_available_time in step S13, the process moves to step S14.

In step S14, the communication control unit 55 of AP MLD1 transmits a frame including the transmission_time_available specifying information on link1 (at time T5 of FIG. 5).

For example, the MLO CTS frame shown in FIG. 5 is transmitted as a frame including the transmission_time_available specifying information.

In this case, the device on the receiving end determines whether or not it is the MLO CTS frame by whether or not an MLO CTS frame added with a control frame extension is defined in the Frame Control field. For example, a prior frame exchange such as a capability information exchange may request a confirmation of a multi-link extension, which is an extension field following the CTS, even in a case where the MLO CTS frame is not defined but the conventional CTS frame is indicated in the Frame Control field.

AP MLD1 may enable itself to transmit data within the TXOP of non-AP STA3 such as by setting the change_availability_information of the communication direction in the RDG/More PPDU subfields in the MLO CTS frame to 1 using Reverse Direction Protocol, for example. Furthermore, the transmission_available_time is set such that it is until the transmission end time of non-AP STA2 in non-AP MLD1 on link2, for example.

Note that as the frame including the transmission_time_available specifying information, a control frame in a new format including the transmission_time_available specifying information may be used instead of the MLO CTS frame.

At the transmission end time specified in the MLO CTS frame (time T7 of FIG. 5), the transmission of Data3 frame on link1 is completed and the transmission of Data1 frame on link2 is completed. At that time, the communication control unit 55 of AP MLD1 transmits ACK3 frame in response to Data3 frame on link1 and transmits ACK1 frame in response to Data1 frame on link2.

In step S15, the communication control unit 55 of AP MLD1 transmits a data frame to the subordinate terminals on link1.

For example, a single user transmission destined for the non-AP STA in the non-AP MLD (non-AP STA1) on link1 or a DL MU transmission that includes the non-AP STA in the non-AP MLD (non-AP STA1) in the destination on link1 is performed (at time T10 of FIG. 5).

Note that at this time, a single user transmission destined for the non-AP STA in the non-AP MLD (non-AP STA2) on link2 may be performed.

If it is determined in step S13 that it is not necessary to specify the transmission_available_time, then the process ends.

### <Process of Non-AP MLD>

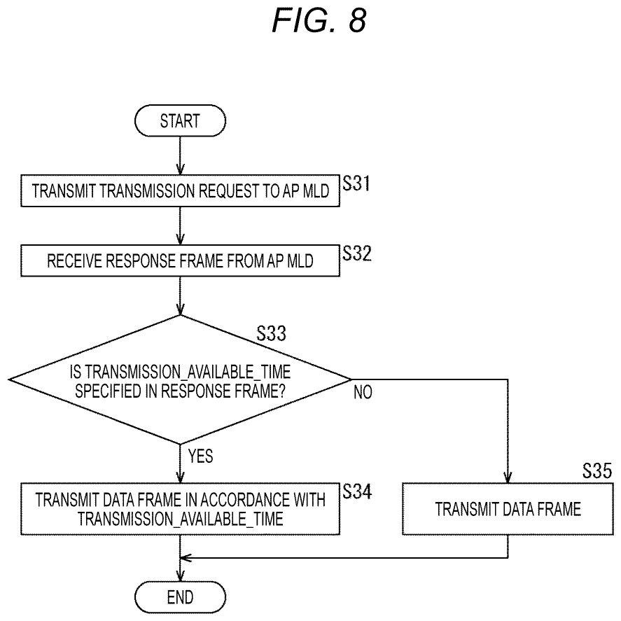

FIG. 8 is a flowchart describing a process of the non-AP MLD.

In step S31, the communication control unit 55 in the non-AP MLD acquires the transmission right and transmits an RTS frame, which is a transmission request, to the AP MLD (at time T4 of FIG. 5).

In step S32, the communication control unit 55 in the non-AP MLD receives a response frame to the RTS frame, which is transmitted from the AP MLD (at time T5 of FIG. 5).

In step S33, the communication control unit 55 in the non-AP MLD determines whether or not the transmission_available_time is specified in the response frame.

For example, if the response frame is the MLO CTS frame, then it is determined in step S33 that the transmission_available_time is specified, and the process moves to step S34.

In step S34, the communication control unit 55 in the non-AP MLD transmits a Data frame to the AP MLD in accordance with the transmission_available_time (at time T6 of FIG. 5). Then, the process ends.

For example, if the response frame is the conventional CTS frame, then it is determined in step S33 that the transmission_available_time is not specified, and the process moves to step S35.

In step S35, the communication control unit 55 in the non-AP MLD transmits the Data frame to the AP MLD.

Then, the process ends.

### 4. Others

### Effect of Present Technology

As described above, in the present technology, during the transmission by the non-STR non-AP MLD on link1, the transmission time of a different non-AP MLD on link2 is adjusted in accordance with the transmission time of the non-STR non-AP MLD on link1.

Therefore, this may reduce the waiting time for transmission and reception on link1 after the non-AP MLD completes the transmission on link2. This may increase the reception opportunities for the non-AP MLD on link1.

Furthermore, the present technology transmits the DL at the transmission opportunity acquired by the non-AP MLD, using Reverse Direction Protocol indicating whether or not to change the communication direction.

This may increase the DL transmission opportunities for the AP MLD.

In this way, the opportunities for transmission and reception may be increased.

### Computer Configuration Example

The series of processes described above may be performed by hardware or by software. In a case where the series of processes are performed by software, programs forming the software are installed from a program recording medium into a computer incorporated in dedicated hardware or a general purpose personal computer or the like.

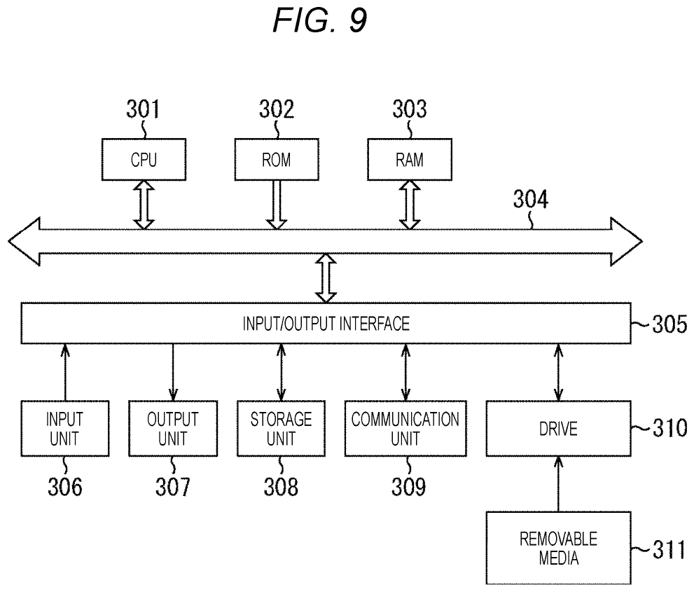

FIG. 9 is a block diagram showing a configuration example of computer hardware that performs the series of processes described above by programs.

A central processing unit (CPU) 301, a read only memory (ROM) 302, and a random access memory (RAM) 303 are interconnected via a bus 304.

An input/output interface 305 is also connected to the bus 304. An input unit 306 including such as a keyboard and a mouse, and an output unit 307 including such as a display and a speaker are connected to the input/output interface 305. Also, a storage unit 308 including such as a hard disk and a non-volatile memory, a communication unit 309 including such as a network interface, and a drive 310 for driving a removable media 311 are connected to the input/output interface 305.

The computer configured as described above performs the series of processes described above by the CPU 301 loading a program stored in the storage unit 308 into the RAM 303 via the input/output interface 305 and bus 304 and executing it, for example.

The program executed by the CPU 301 is stored in the removable media 311, or provided via a wired or wireless transmission medium such as a local area network, the Internet, or digital broadcasting, and then installed in the storage unit 308, for example.

Note that the program executed by a computer may be a program that is processed in time series in the order described in the present specification or a program that is processed in parallel or at necessary timings such as when it is called.

Note that in the present specification, a system means a set of a plurality of components (such as devices, modules (parts)), and it does not matter whether or not all the components are in the same housing. Therefore, a plurality of devices contained in separate housings and connected via a network, and one device including a plurality of modules contained in one housing are both systems.

Furthermore, the effects described in the present specification are merely examples and not limiting, and there may also be other effects.

Embodiments of the present technology are not limited to the above-described embodiments, and various modifications may be made without departing from the spirit of the present technology.

For example, the present technology may be configured as cloud computing in which one function is shared by a plurality of devices through a network for processing in cooperation.

Furthermore, each step described in the above described flowchart may be performed by one device or by a plurality of devices in a shared manner.

Additionally, in a case where a plurality of processes is included in one step, the plurality of processes included in the one step may be performed by one device or by a plurality of devices in a shared manner.

### Combination Examples of Configurations

The present technology may also have the following configurations.

(1)

A wireless communication device including:
a communication unit configured to communicate with a wireless communication terminal on a plurality of links; and
a communication control unit configured to transmit, when receiving a transmission request frame for a first frame transmitted from the wireless communication terminal on a first link, transmission_available_time specifying information that specifies a transmission_available_time of the wireless communication terminal on the first link, to the wireless communication terminal.
   (2)

The wireless communication device according to (1), in which
the communication control unit determines whether or not to specify the transmission_available_time on the first link on the basis of at least one of a second frame received on a second link, the transmission request frame received on the first link, and information in the communication control unit itself, and if it is determined to specify the transmission_available_time on the first link, then transmits the transmission_available_time specifying information.
   (3)

The wireless communication device according to (2), in which
if a transmission request time indicated by the transmission request frame received on the first link is longer than a transmission end time of the second frame transmitted by the wireless communication terminal on the second link, the communication control unit determines to specify the transmission_available_time and transmits the transmission_available_time specifying information.
   (4)

The wireless communication device according to (3), in which
the transmission_available_time specified in the transmission_available_time specifying information is a transmission end time of the second frame transmitted on the second link.
   (5)

The wireless communication device according (1) to

(4), in which
the communication control unit transmits the transmission_available_time specifying information by a response frame to the transmission request frame.
   (6)

The wireless communication device according to (5), in which
the response frame is an extended response frame added with an extension field including the transmission_available_time specifying information.
   (7)

The wireless communication device according to (6), in which
the response frame including information indicating a change of a communication direction.
   (8)

The wireless communication device according to (7), in which
after receiving the first frame transmitted from the wireless communication terminal on the first link, the communication control unit transmits a third frame to at least one of the wireless communication terminal and a different wireless communication terminal on the first link.
   (9)

A wireless communication method including,
communicating, by a wireless communication device, with a wireless communication terminal on a plurality of links; and
transmitting, by the wireless communication device, when receiving a transmission request frame for a first frame transmitted from the wireless communication terminal on a first link, transmission_available_time specifying information that specifies a transmission_available_time of the wireless communication terminal on the first link, to the wireless communication terminal.
   (10)

A wireless communication terminal including:
a communication unit configured to communicate with a wireless communication device on plurality of links; and
a communication control unit configured to transmit a first frame to the wireless communication device on a first link in accordance with a transmission_available_time of the first frame on the first link that is specified in transmission_available_time specifying information included in a response frame transmitted by the wireless communication device in response to a transmission request frame for the first frame transmitted to the wireless communication device on the first link.
   (11)

The wireless communication terminal according to

(10), in which
the communication control unit determines whether or not the response frame includes the transmission_available_time specifying information, and if it is determined that the transmission_available_time specifying information is included, then transmits the first frame to the wireless communication device on the first link in accordance with the transmission_available_time.
   (12)

The wireless communication terminal according to claim (11), in which
the transmission_available_time specified in the transmission_available_time specifying information is a transmission end time of a second frame transmitted by a different wireless communication terminal on a second link.
   (13)

The wireless communication terminal according to

(11) or (12), in which
the response frame is an extended response frame added with an extension field including the transmission_available_time specifying information.
   (14)

The wireless communication terminal according to

(13), in which
the extended response frame includes information indicating a change of a communication direction.
   (15)

A wireless communication method including:
communicating, by a wireless communication terminal, with a wireless communication device on a plurality of links; and
transmitting, by the wireless communication terminal, a first frame to the wireless communication device on a first link in accordance with a transmission_available_time of the first frame on the first link that is specified in transmission_available_time specifying information included in a response frame transmitted by the wireless communication device in response to a transmission request frame for the first frame transmitted to the wireless communication device on the first link.

### REFERENCE SIGNS LIST

11 Wireless communication device
31 Communication unit
54 Data processing unit
55 Communication control unit
54 Communication storage unit
61, 61-1, 61-2 Individual data processing unit
62 Common data processing unit
71, 71-1, 71-2 Individual control unit
72 Common control unit

1. A wireless communication device comprising:
a communication unit configured to communicate with a wireless communication terminal on a plurality of links; and
a communication control unit configured to transmit, when receiving a transmission request frame for a first frame transmitted from the wireless communication terminal on a first link, transmission_available_time specifying information that specifies a transmission_available_time of the wireless communication terminal on the first link, to the wireless communication terminal.

2. The wireless communication device according to claim 1, wherein
the communication control unit determines whether or not to specify the transmission_available_time on the first link on a basis of at least one of a second frame received on a second link, the transmission request frame received on the first link, and information in the communication control unit itself, and if it is determined to specify the transmission_available_time on the first link, then transmits the transmission_available_time specifying information.

3. The wireless communication device according to claim 2, wherein
if a transmission request time indicated by the transmission request frame received on the first link is longer than a transmission end time of the second frame transmitted by the wireless communication terminal on the second link, the communication control unit determines to specify the transmission_available_time and transmits the transmission_available_time specifying information.

4. The wireless communication device according to claim 3, wherein
the transmission_available_time specified in the transmission_available_time specifying information is a transmission end time of the second frame transmitted on the second link.

5. The wireless communication device according to claim 1, wherein
the communication control unit transmits the transmission_available_time specifying information by a response frame to the transmission request frame.

6. The wireless communication device according to claim 5, wherein the response frame is an extended response frame added with an extension field comprising the transmission_available_time specifying information.

7. The wireless communication device according to claim 6, wherein
the response frame comprises information indicating a change of a communication direction.

8. The wireless communication device according to claim 7, wherein
after receiving the first frame transmitted from the wireless communication terminal on the first link, the communication control unit transmits a third frame to at least one of the wireless communication terminal and a different wireless communication terminal on the first link.

9. A wireless communication method comprising:
communicating, by a wireless communication device, with a wireless communication terminal on a plurality of links; and
transmitting, by the wireless communication device, when receiving a transmission request frame for a first frame transmitted from the wireless communication terminal on a first link, transmission_available_time specifying information that specifies a transmission_available_time of the wireless communication terminal on the first link, to the wireless communication terminal.

10. A wireless communication terminal comprising:
a communication unit configured to communicate with a wireless communication device on plurality of links; and
a communication control unit configured to transmit a first frame to the wireless communication device on a first link in accordance with a transmission_available_time of the first frame on the first link that is specified in transmission_available_time specifying information comprised in a response frame transmitted by the wireless communication device in response to a transmission request frame for the first frame transmitted to the wireless communication device on the first link.

11. The wireless communication terminal according to claim 10, wherein
the communication control unit determines whether or not the response frame comprises the transmission_available_time specifying information, and if it is determined that the transmission_available_time specifying information is comprised, then transmits the first frame to the wireless communication device on the first link in accordance with the transmission_available_time.

12. The wireless communication terminal according to claim 11, wherein
the transmission_available_time specified in the transmission_available_time specifying information is a transmission end time of a second frame transmitted by a different wireless communication terminal on a second link.

13. The wireless communication terminal according to claim 11, wherein
the response frame is an extended response frame added with an extension field comprising the transmission_available_time specifying information.

14. The wireless communication terminal according to claim 13, wherein
the extended response frame comprises information indicating a change of a communication direction.

15. A wireless communication method comprising:
communicating, by a wireless communication terminal, with a wireless communication device on a plurality of links; and
transmitting, by the wireless communication terminal, a first frame to the wireless communication device on a first link in accordance with a transmission_available_time of the first frame on the first link that is specified in transmission_available_time specifying information comprised in a response frame transmitted by the wireless communication device in response to a transmission request frame for the first frame transmitted to the wireless communication device on the first link.
